(19) United States
(12) Patent Application Publication
(10) Pub. No.: US 2007/0065289 A1
(43) Pub. Date: Mar. 22, 2007

(54) Helicopter speed display for displaying maximum airspeed

(76) Inventor: Randall A. Greene, Greenwich, CT (US)

Correspondence Address: LOWE HAUPTMAN BERNER, LLP, 1700 DIAGONAL ROAD, SUITE 300, ALEXANDRIA, VA, 22314, US

(21) Appl. No.: 11/228,243

(22) Filed: Sep. 19, 2005

(51) Int. Cl. B64C 27/46

(52) U.S. Cl. 416/223 R

(57) ABSTRACT

A helicopter speed display for displaying the maximum speed of a helicopter under current conditions is disclosed. The display includes a first scale indicative of the actual airspeed of a helicopter and a second scale juxtapositioned on the first scale for displaying a maximum airspeed under current conditions of altitude, temperature and weight in order to avoid retreating blade stall.

### FIELD OF THE INVENTION

This invention relates to a speed display system for displaying the maximum airspeed of a helicopter under current conditions and more particularly to a display and/or system for simultaneously displaying the actual speed of the helicopter and the maximum airspeed that if exceeded could result in retreating blade stall.

### BACKGROUND FOR THE INVENTION

Helicopters have a unique position among aircraft in that they can stall by going too fast. For example, fixed wing aircraft may have structural limitations. However, on a helicopter, the advancing rotary blade has a higher air velocity then the retreating blade due to the summation of the velocity due to forward flight and the velocity due to the rotational speed of the blade. By contrast, the retreating blade has a lower air velocity due to the velocity of forward flight minus the velocity of the retreating blade. It is also well known to those of ordinary skill in the art that due to the flapping hinges or teeter mechanism, the helicopter's retreating blade will have a higher angle of attack then the advancing blade. Therefore, as the forward airspeed is increased, the velocity of airflow over the retreating blade will decrease eventually resulting in an angle of attack that exceeds the stall angle of attack. In this instance, the stall on the retreating blade will start at the tip and advance in an inward direction. The stall is then considered severe if the outer 25% of the blade is above the stall angle of attack. With a severe stall, the helicopter can become uncontrollable with a possibility of the loss of the aircraft and personnel.

In addition, to high speed flight, other conditions that can lead to retreating blade stall include low rotor speed, high gross weight, altitude, high load factor due to steady state high bank angle, abrupt control deflections and turbulent air with strong up drafts creating a momentary increase in the angle of attack.

In view of the above, helicopter manufacturers take such conditions into account in published tables in the Limitations section of the Flight Manual. This information is to advise pilots of the maximum airspeed to avoid a retreating blade stall. The problem with this approach is that the information in flight is dynamic. For example, the airspeed limit varies as the altitude of the helicopter changes and it changes with the temperature and gross weight. The problem is that a pilot cannot continuously be calculating a stall speed as the helicopter conditions change. Therefore, a pilot typically takes an overly cautious approach and uses a speed that is less than optimum.

It is now believed that there may be a large commercial market for a helicopter speed display and system for simultaneously displaying actual speed together with the dynamic maximum safe airspeed to avoid retreating blade stall in accordance with the present invention. It is believed that there will be a commercial market for such displays and such systems since they continuously indicate the actual speed and the maximum safe airspeed side-by-side or juxtapositioned in a manner to clearly indicate how close the aircraft is to its maximum safe speed. It is also believed that such displays and such systems can be manufactured at a competitive price, are durable, relatively easy to install and service, reliable and will enable a pilot to fly closer to a maximum speed safely.

### BRIEF SUMMARY OF THE INVENTION

In essence, the present invention contemplates a helicopter speed display wherein a first scale indicates the actual airspeed of a helicopter and a second scale indicates the maximum speed limit to avoid retreating blade stall adjacent to or juxtapositioned on the first scale. In a preferred embodiment of the invention, the display includes an arc or ring-shaped lighted segment which is analogous to the red line as indicated on the tachometer for land-based motor vehicles.

A further embodiment of the invention contemplates a helicopter high speed limit display system for indicating the actual airspeed of the aircraft and the speeds above which there is an imminent danger of a retreating blade stall juxtapositioned on the aircraft's actual airspeed. The system includes means for sensing the airspeed of a helicopter and for producing a signal indicative of the helicopter's actual airspeed. The system also includes means such as a barometric altimeter for sensing the altitude of the aircraft and for producing a signal indicative of the altitude of the aircraft. In addition to the above, the system includes means for indicating the gross weight of the helicopter as for example, a manual switch operated by the pilot to indicate whether the gross weight of the aircraft is above or below a preselected value such as 3,000 pounds. In this embodiment of the invention, a micro controller or computer includes two look-up tables, one for above 3,000 pounds and one for below 3,000 pounds and a display. The micro controller or computer processes the signals indicative of the altitude, temperature and weight and compares those values to the values in the look-up tables. The micro controller then produces an output signal to display the actual airspeed and the airspeed limit for avoiding retreating blade stall, so that, a pilot can fly at an airspeed which is close to the limit.

The invention will now be described in connection with the accompanying drawings wherein like reference numbers are used to designate like parts.

### BRIEF DESCRIPTION OF THE DRAWINGS

FIG. 1 is a schematic block diagram illustrating a helicopter airspeed display system in accordance with a first embodiment of the present invention;

FIG. 2A is a table of airspeed limitations for a Bell JetRanger-III for gross weights below 3,000 pounds and is typical of flight manual limitations on airspeed;

FIG. 2B is a table of airspeed limitations for a Bell JetRanger-III for gross weights above 3,000 pounds and is typical of flight manual limitations on airspeed.

FIG. 3A is a front view of an arc or ring-shaped display board incorporated in one embodiment of the invention;

FIG. 3B is a rear view of the arc-shaped display board shown in FIG. 3A;

FIG. 3C is a schematic illustration of the arc-shaped display board shown in FIGS. 3A and 3B and a faceplate including a slit for accommodating a series of LEDs;

FIG. 4A is a face view of a helicopter airspeed display in accordance with the present invention;

FIG. 4B is a face view of a helicopter airspeed display in accordance with the present invention as shown in FIG. 4A but with an airspeed limit shown thereon; and

FIG. 4C is a face view of the helicopter display shown in FIGS. 4A and 4B but with a band display showing an airspeed limit.

### DESCRIPTION OF THE PREFERRED EMBODIMENTS OF THE INVENTION

Basically, the helicopter airspeed display system in accordance with the present invention starts with a normal airspeed indication and adds a dynamic stall warning indication or warning to a pilot. The normal airspeed indicator is of conventional design and may take several forms as for example, a circular shape which is analogous to the face of a clock. It may be of a type having an internal pneumatic bellows, an electrically driven unit or other conventional mechanism and will not be described in detail.

In the present invention, the indication of a maximum airspeed for avoiding retreating blade stall under current conditions can be in the form of a second pointer, a lighted segment adjacent to the airspeed indicator or on a ring adjacent to the airspeed indicator. The dynamic stall warning indicator displays to the pilot the airspeed or airspeed band that should not be exceeded under current conditions. It is somewhat analogous to a red line on a tachometer for motor vehicles. However, unlike a tachometer on a motor vehicle, operation above the maximum speed can result in the loss of control of the helicopter and loss of life.

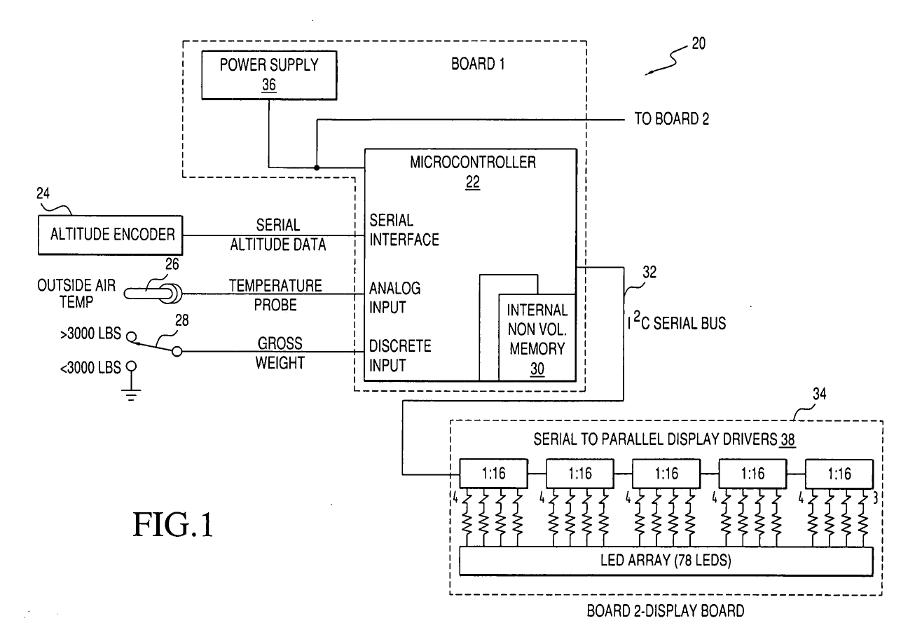

Referring now to FIG. 1, a helicopter airspeed display system 20 for displaying maximum airspeed includes a computer or micro controller 22 and an altitude encoder 24 for producing a signal indicative of the aircraft's present altitude. The signal indicative of present altitude is then fed to the micro controller 22. The altitude is derived from a conventional barometric altimeter or the like. The output of a conventional temperature sensor 26 is also fed to the micro controller 22. The micro controller 22 reads the current altitude from the altitude encoder 24 or other altitude sensor and the outside air temperature from the temperature sensor 26 such as a conventional electronic thermometer.

The pilot selects the gross weight of the aircraft with a toggle switch 28 to indicate whether the gross weight of the aircraft is above or below a preselected weight such as 3,000 pounds. This selection is then read by the micro controller 22. The micro controller 22 reads the inputs from the altitude encoder 24, temperature sensor 26 and switch 28 in a periodic manner in order to continuously update the pilot's display of the maximum airspeed limit.

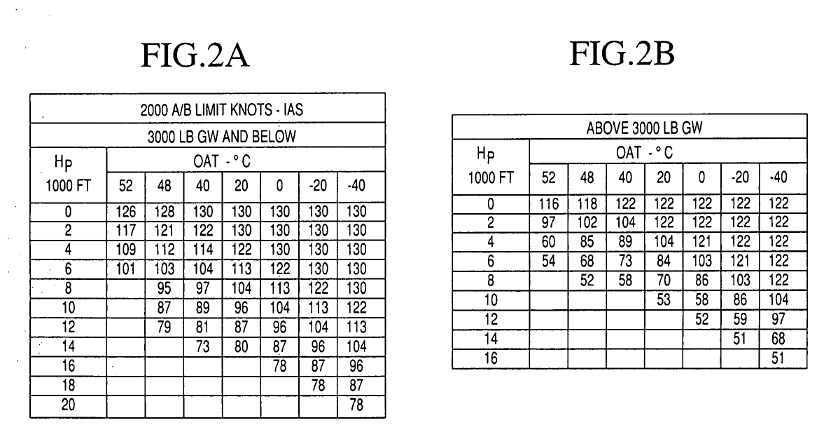

The micro controller 22 accesses one of the two tables (see FIG. 2) stored in a non-volatile memory 30 depending on the position of the switch 28. The micro controller 22 interpolates between the stored values to calculate the airspeed limit for the particular conditions and sends a bit stream over a serial bus such as an I²C bus 32 to a display board 34. A power supply 36 supplies the appropriate voltage to the electronics on both boards.

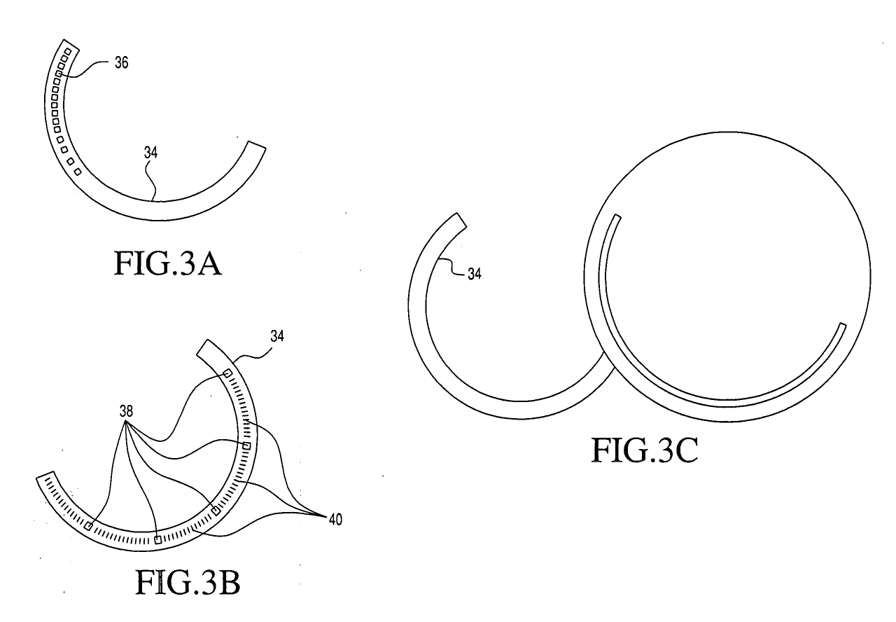

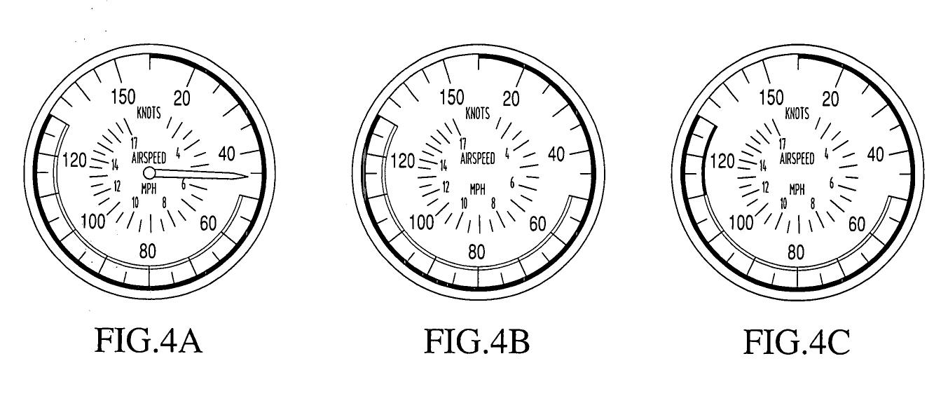

In a preferred embodiment of the invention, the display board 34 as shown in FIGS. 3A-3C is a curved printed circuit board with LEDs 36 on one side and the serial to parallel conversion drivers 38 and limiting resistors 40 on the other side. The display 34 is curved in order to fit between the dial face on the airspeed indicator 42 as shown in FIG. 3C and FIGS. 4A-4C. As illustrated, the dial face 42 includes a slit 44 in the shape of a segment of a circle cut into the dial face to allow the LEDs 36 to shine through the display. For the Bell JetRanger-III the airspeed limit varies from a high of 130 knots to a low of 51 knots. Therefore, in this implementation, there are 79 LEDs which provide one-knot resolution on the warning display integrated into the airspeed indicator.

FIG. 4A shows an assembled unit, while FIG. 4B shows the display with the particular airspeed limit enunciated by a single LED. In FIG. 4C an airspeed band is enunciated or illuminated. While the airspeed indicator show has a maximum airspeed of 150 knots, other instruments for other aircraft will have other airspeed indicators with different maximum values. Other aircraft will also incorporate speed limit values taken from a flight manual associated with that aircraft.

While the invention has been described in connection with its preferred embodiments, it should be recognized that changes and modifications may be made therein without departing from the scope of the appended claims.

What is claimed is:

1. A helicopter speed display comprising a first scale indicative of the actual airspeed of a helicopter and a second scale indicative of the maximum speed limit to avoid retreating blade stall adjacent said first scale.

2. A helicopter speed display according to claim 1, which includes means for displaying an aircraft airspeed band that should not be exceeded under present conditions.

3. A helicopter speed display according to claim 2, which includes first and second pointers.

4. A helicopter speed display according to claim 2, which includes a lighted segment on said second scale.

5. A helicopter speed display according to claim 2, in which said first scale is ring-shaped and said second scale is juxtapositioned on said first scale.

6. A helicopter speed display according to claim 5, which includes a plurality of light emitting diodes to display speeds that should be avoided to avoid retreating blade stall.

7. A helicopter speed display according to claim 6, which includes a micro controller and speed limit tables indicative of the maximum speed limits of the helicopter under current conditions.

8. A helicopter speed display according to claim 7, which includes means for sensing the altitude of the helicopter and for inputting a signal indicative of the altitude of the helicopter into said micro controller.

9. A helicopter speed display according to claim 8, which includes means for sensing the ambient temperature and for inputting a signal indicative of the ambient temperature into said micro controller.

10. A helicopter high speed limit display system comprising:
means for sensing the airspeed of a helicopter and for producing a signal indicative of the helicopter's airspeed;
means for sensing the altitude of the helicopter and for producing a signal indicative of the altitude of the helicopter;
means for sensing the ambient temperature and for producing a signal indicative of the ambient temperature;
means for indicating the gross weight of the helicopter;
a computer including a look-up table for indicating the maximum safe airspeed of the helicopter at selected altitudes, temperatures and weights; and,
means for simultaneously displaying the airspeed of the helicopter and the safe airspeed to avoid retreating blade stall adjacent to the actual airspeed.

11. A helicopter high speed limit display system according to claim 10, which includes a display having a lighted segment for indicating airspeeds that would cause retreating blade stall under current conditions juxtaposed on a display for indicating actual airspeed.

12. A helicopter high speed limit display system according to claim 11, which includes a plurality of light emitting diodes to display the stall speed limit.

13. A helicopter high speed limit display system according to claim 12, which includes a switch for a pilot to select a gross weight of the aircraft and an indication of whether the aircraft is above or below the selected weight.

14. A helicopter high speed limit display system according to claim 13, which includes a curved printed circuit board configured to fit behind an air shaped airspeed indicator.

15. A helicopter high speed limit display system according to claim 14, in which the arc shaped airspeed indicator includes a semicircular slit to allow light from light emitting diodes to show therethrough.

16. A helicopter speed display according to claim 1, in which said first scale is ring shaped and includes a ring-shaped slit therein and wherein a plurality of light emitting diodes are disposed behind said slit and configured to shine through said slit as a warning not to exceed an indicated airspeed.
